(19) United States
(12) Patent Application Publication
(10) Pub. No.: US 2005/0041421 A1
(43) Pub. Date: Feb. 24, 2005

(54) Light fixture assembly

(76) Inventors: Gary Lamolinara, Latrobe, PA (US); Edward Lamolinara, Latrobe, PA (US)

Correspondence Address: PAUL A. BECK & ASSOCIATES;SUITE 100, 1575 McFARLAND ROAD, PITTSBURGH, PA, 15216-1808, US

(21) Appl. No.: 10/645,377

(22) Filed: Aug. 21, 2003

(51) Int. Cl. H01R 33/00

(52) U.S. Cl. 362/226

(57) ABSTRACT

his invention provides a light fixture assembly having a light fixture body and a mount for the light fixture body and method for installing a light fixture. There is a locking mechanism for nonthreadably releaseably coupling the light fixture body to the mount. A first portion of the locking mechanism attached to the light fixture body. A second portion of the locking mechanism attached to the mount. The light fixture body can be attached to the mount. The locking means can include twist locking the light fixture body to the mount

### BACKGROUND OF THE INVENTION

1. Field of the Invention

This invention relates in general to a light fixture and more specifically to a light fixture assembly.

2. Description of the Related Art

Light fixtures in general can be mounted in three different ways. A light fixture can be mounted to a wall (coach lantern), to a post (post lantern), or hung by a chain (chain lantern).

Because of this prior art light fixtures have to come in three different models with the light fixture body being common to all. If a consumer wants a wall mounted light fixture they would buy the coach lantern model. If a consumer was a post mounted light fixture they would buy the post lantern. If a consumer wants a chain mounted light fixture they would buy the chain lantern.

This creates an inventory problem for the retail store owner. For each style of light fixture retail stores must keep three different models in inventory in order to fulfill consumers' different mounting needs. This can take up limited inventory space and requires retail stores to carry fewer styles of lighting fixtures.

One prior art light fixture designed to solve this problem has been created by Royce Lighting Company. Royce has attempted to solve this problem buy putting a convertible light fixture on the market. However, this attempt is deficient because it requires a person to disassemble the light fixture with tools and then be reassembled by a skilled technician with tools (in order for it too meet UL requirements) to the desired mounting arrangement.

### BRIEF SUMMARY OF THE INVENTION

The object of this invention is to provide a light fixture in one box that can be mounted all three different ways.

Another object of this invention is to provide a light fixture in one box that can be assembled without tools or special training to be mounted in three different ways.

This invention provides a light fixture assembly having a light fixture body and a mount for the light fixture body. There is a locking mechanism for nonthreadably releaseably coupling the light fixture body to the mount. A first portion of the locking mechanism attached to the light fixture body. A second portion of the locking mechanism attached to the mount. The light fixture body can be attached to the mount. The locking means can include twist locking the light fixture body to the mount.

### Brief Description of the Drawings

FIG. 1. shows a front plan view of the post lantern fully assembled connected to a post;

FIG. 2. shows a front plan view of the post lantern with the post mount and finishing piece detached;

FIG. 3. shows a perspective view of the bottom of the light fixture body and the locking mechanism with the post mount;

FIG. 4. shows a perspective view of the top of the light fixture body and the locking mechanism with the post mount;

FIG. 5. shows a side plan view of a bottom mounted coach assembly;

FIG. 6. shows a side plan view of a bottom mounted coach assembly with the coach mount and finishing piece detached;

FIG. 7. shows a perspective view of the bottom of the light fixture body and the locking mechanism for coach mount of a bottom mounted coach assembly;

FIG. 8. shows a perspective view of the top of the light fixture body and the locking mechanism for the finishing piece of a bottom mounted coach assembly;

FIG. 9. shows a side plan view of a top mounted coach assembly with the coach mount and finishing piece detached;

FIG. 10. shows a perspective view of the bottom of the light fixture body and the locking mechanism for the finishing piece of a top mounted coach assembly;

FIG. 11. shows a perspective view of the top of the light fixture body and the locking mechanism for a coach mount of top mounted coach assembly;

FIG. 12 shows a front plan view of chain lantern assembly;

FIG. 13 shows a front plan view of a chain lantern with chain mount and finishing piece detached;

FIG. 14. shows a perspective view of the bottom of the light fixture body and the locking mechanism for the finishing piece of a chain lantern; and

FIG. 15. shows a perspective view of the top of the light fixture body and the locking mechanism for the chain mount of a chain lantern.

### DETAILED DESCRIPTION OF THE PERFERRED EMBODIMENT

### Definitions

“light fixture assembly”—A fully assembled Light fixture ready for installation
“light fixture body”—The main portion of a lantern, to which one of several mounting bracket styles can be attached.
“mount for the light fixture body”—Usually an extension or a bracket attached to the main body used for placement of the light fixture on a permanent structure.
“support structure”—A body other than the lantern which supports the light fixture i.e. a post, a wall, or a roof.
“locking mechanism”—A mechanical device that secures the main body to the mount.
“releaseably coupling”—A mechanical device that attaches the main body to the mounting bracket in a secure way but, may also be reversed and disassembled to attach other mounting brackets for alternative uses.
“twist locking”—The action necessary for locking the releaseably coupling to engage or disengage.
“twist locking the light fixture body to the mount”—The action of inserting the mounting brackets releaseably coupling (first portion) in to the light fixtures main body (second portion) and securing the two together with a twist.
“a first portion of the locking mechanism”—The female end of the releaseably coupling attached to the main body of the light.
“a second portion of the locking mechanism”—The male end of the releaseably coupling attached to the mounting bracket.
“attached to the light fixture body”—The device is secured and becomes part of the light fixture body.
“attached to the mount”—The device is secured and becomes part of the mount.
“light fixture body is attached to the mount”—the first portion and second portion of the releaseably coupling attach together with a twist creating a light fixture assembly.
“nonthreadably”—Without threads.

### Description

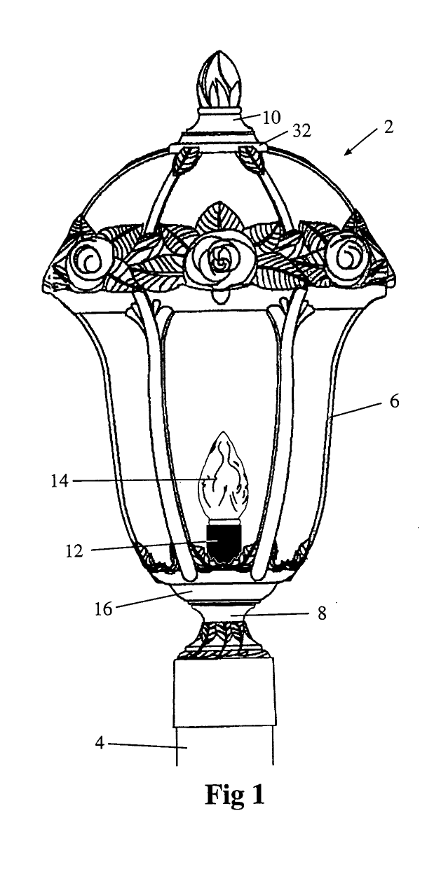

FIG. 1 shows a fully assembled post lantern 2 mounted to a support structure 4. The fully assembled post lantern 2 includes a light fixture body 6, a post mount 8 for the light fixture body 6, and a finishing piece 10. The post mount 8 is coupled to the bottom 16 of the light fixture body 6. The post mount 8 for the light fixture body 6 contains a lighting socket 12. The lighting socket 12 contains a light bulb 14. The post mount 8 for the light fixture body 6 is attached to a support structure 4 which in this embodiment is a post. On the top 32 of the light fixture body 6 is a finishing piece 10.

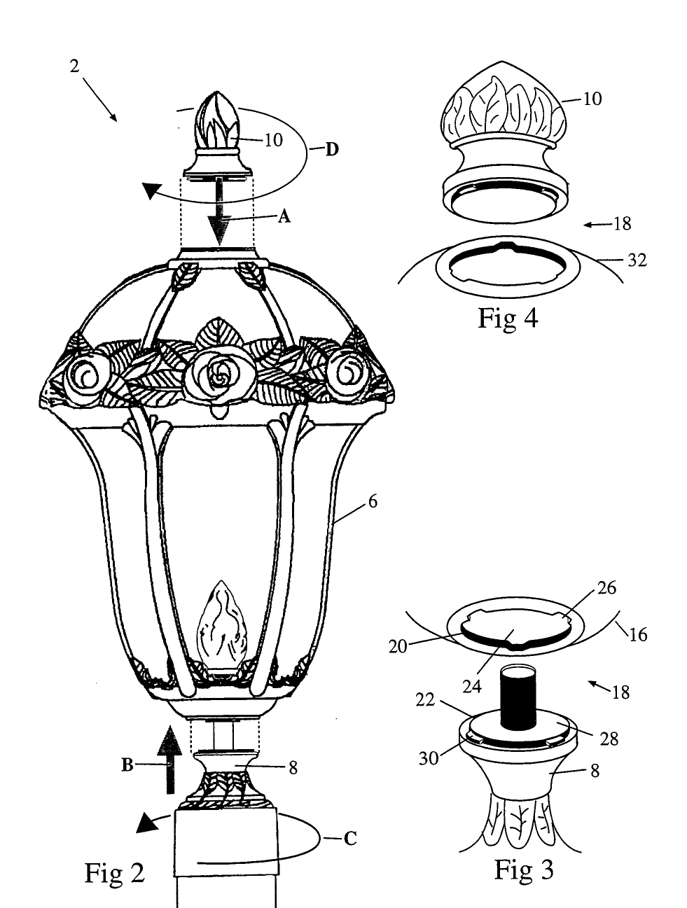

FIG. 2 shows the post lantern 2 with the finishing piece 10 and the post mount 8 for the light fixture body 6 both detached from the light fixture body 6. The finishing piece 10 is inserted into the light fixture body 6 in the direction of arrow A. The finishing piece 10 is then locked into place by twisting finishing piece 10 in the direction of arrow D. The post mount 8 for the light fixture body 6 is inserted into the light fixture body 6 in the direction of arrow B. The post mount 8 for the light fixture body 6 is locked into place by twisting the post mount 8 for the light fixture body 6 in the direction of arrow C.

FIG. 3 shows a bottom 16 of the light fixture body 6. A locking mechanism 18 for nonthreadably releseably coupling the light fixture body 6 to the post mount 8 includes a first portion 20 attached to the light fixture body 6 and a second portion 22 attached to the post mount 8. The first portion 20 of the locking mechanism 18 in this embodiment is a hole 24 with three slots 26 cut out of the outer radius of the hole 24. The second portion 22 of the locking mechanism 18 in this embodiment is a disc 28 having the same diameter as the hole 24, the disc 28 has three tabs 30 designed to fit into the slots 26.

FIG. 4 shows the top 32 of the light fixture body 6 with the finishing piece 10 detached. The finishing piece 10 is attached to the light fixture body 6 by the same locking mechanism 18 that is used to attach the post mount 8 as shown in FIG. 3. Because the locking mechanism 18 for the finishing piece 10 is the same as the locking mechanism 18 for coupling the light fixture body 6 to the post mount 8 the two mechanisms are interchangeable.

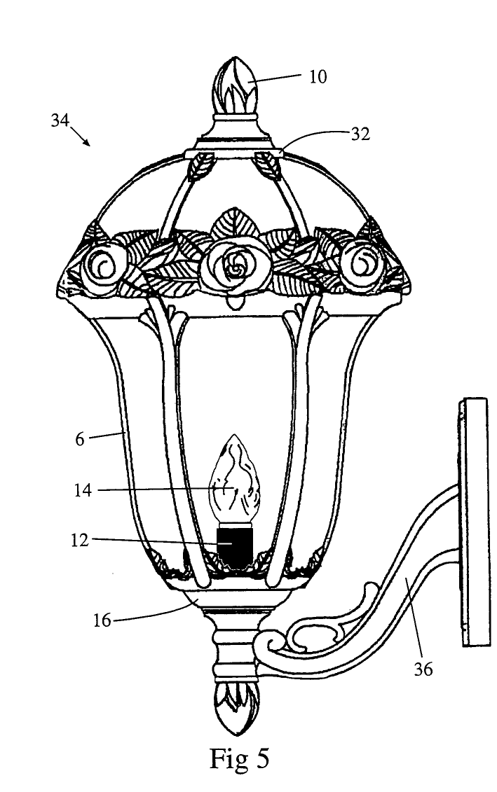

FIG. 5 shows a fully assembled bottom mounted coach lantern 34. The fully assembled bottom mounted coach lantern 34 includes a light fixture body 6, a coach mount 36 mounted on the bottom 16 of the light fixture body 6, and a finishing piece 10 mounted on the top 32 of the light fixture body 6. The light fixture body 6 is coupled to a coach mount 36, the coach mount 36 in this embodiment is designed to be mounted to a wall (not shown) or other support structure. The coach mount 36 for the light fixture body contains a lighting socket 12. The lighting socket 12 contains a light bulb 14. On the top 32 of the light fixture body 6 is a finishing piece 10.

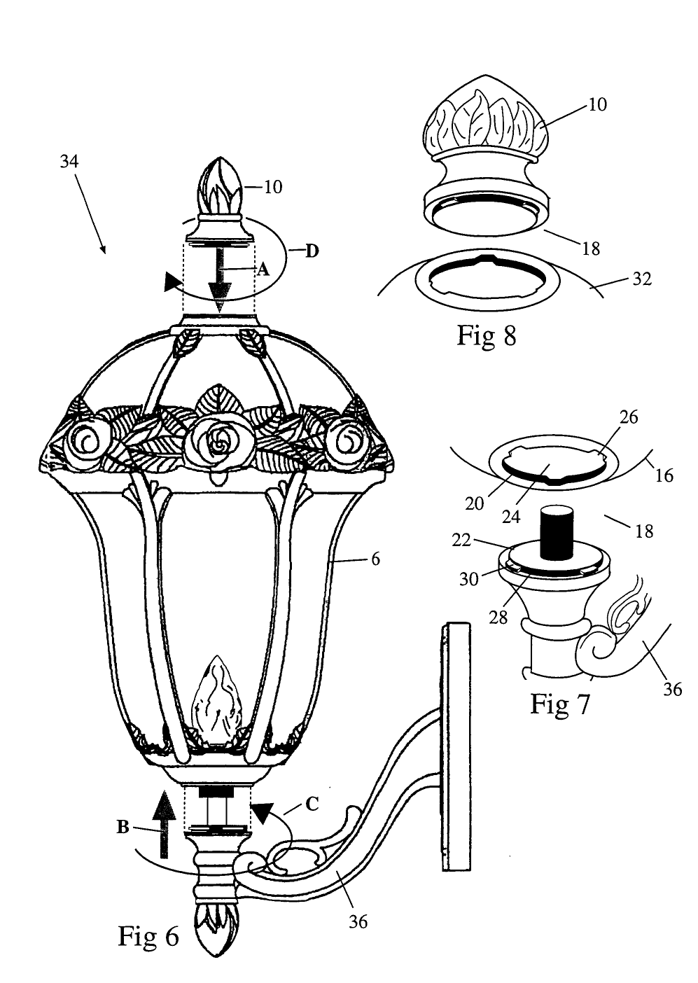

FIG. 6 shows the bottom mounted coach lantern 34 with the finishing piece 10 and the coach mount 36 both detached from the light fixture body 6. The finishing piece 10 is inserted into the light fixture body 6 in the direction of arrow A. The finishing piece 10 is then locked into place by twisting finishing piece 10 in the direction of arrow D. The coach mount 36 for the light fixture body 6 is inserted into the light fixture body 6 in the direction of arrow B. The coach mount 36 is locked into place by twisting the coach mount 36 for the light fixture body 6 in the direction of arrow C.

FIGS. 7 and 8 shows the locking mechanism 18 in use with the coach mount 36. The description for FIGS. 3 and 4 apply except that the coach mount 36 is used instead of the post mount 8.

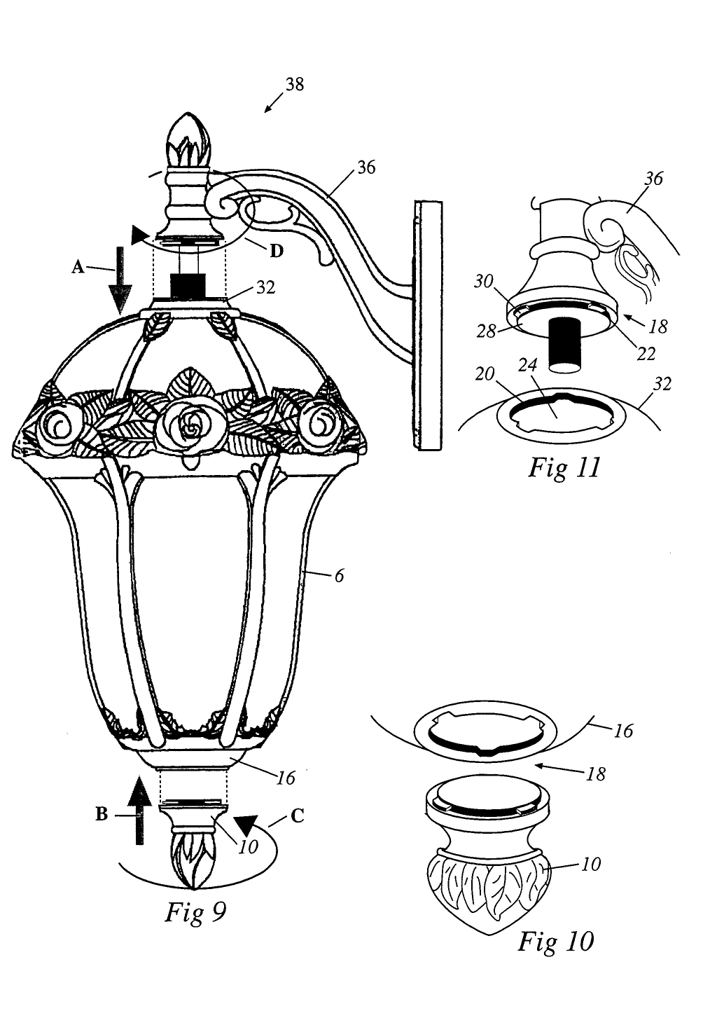

FIG. 9 shows a top mounted coach mount 38 with the finishing piece 10 and the coach mount 36 both detached from the light fixture body 6. The finishing piece 10 is inserted into the bottom 16 of the light fixture body 6 in the direction of arrow B. The finishing piece 10 is locked into place by twisting finishing piece 10 in the direction of arrow C. The coach mount 36 for the light fixture body 6 is inserted into the top 32 of the light fixture body 6 in the direction of arrow A. The coach mount 36 is locked into place by twisting the coach mount 36 in the direction of arrow D.

FIGS. 10 and 11 show the same locking mechanism 18 as shown in FIGS. 3, 4, 7, 8. The structure is the same structure as used in FIGS. 7 & 8 however the coach mount 36 is used on the top 32 of the light fixture body 6 and the finishing piece 10 is on the bottom 16 of the light fixture assembly. This can be done because both the finishing piece 10 and the coach mount 36 have the same locking mechanism 18.

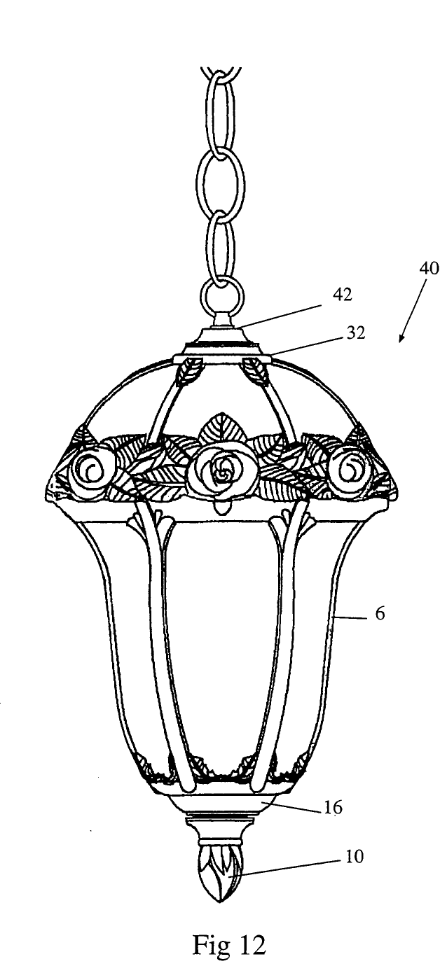

FIG. 12 shows a fully assembled chain lantern 40. The fully assembled chain lantern 40 includes a light fixture body 6, a chain mount 42 mounted on the top 32 of the light fixture body 6, and a finishing piece 10 mounted on the bottom 16 of the light fixture body 6. The light fixture body 6 is coupled to the chain mount 42, the chain mount 36 in this embodiment is designed to be mounted to a support structure not shown. On the bottom 16 of the light fixture body 6 is a finishing piece 10.

FIG. 13 shows a chain lantern 40 with the finishing piece 10 and the chain mount 42 both detached from the light fixture body 6. The finishing piece 10 is inserted into the bottom 16 of the light fixture body 6 in the direction of arrow B. The finishing piece 10 is locked into place by twisting finishing piece 10 in the direction of arrow C. The chain mount 42 for the light fixture body 6 is inserted into top 32 of the light fixture body 6 in the direction of arrow A. The chain mount 42 is locked into place by twisting the chain mount 42 in the direction of arrow D.

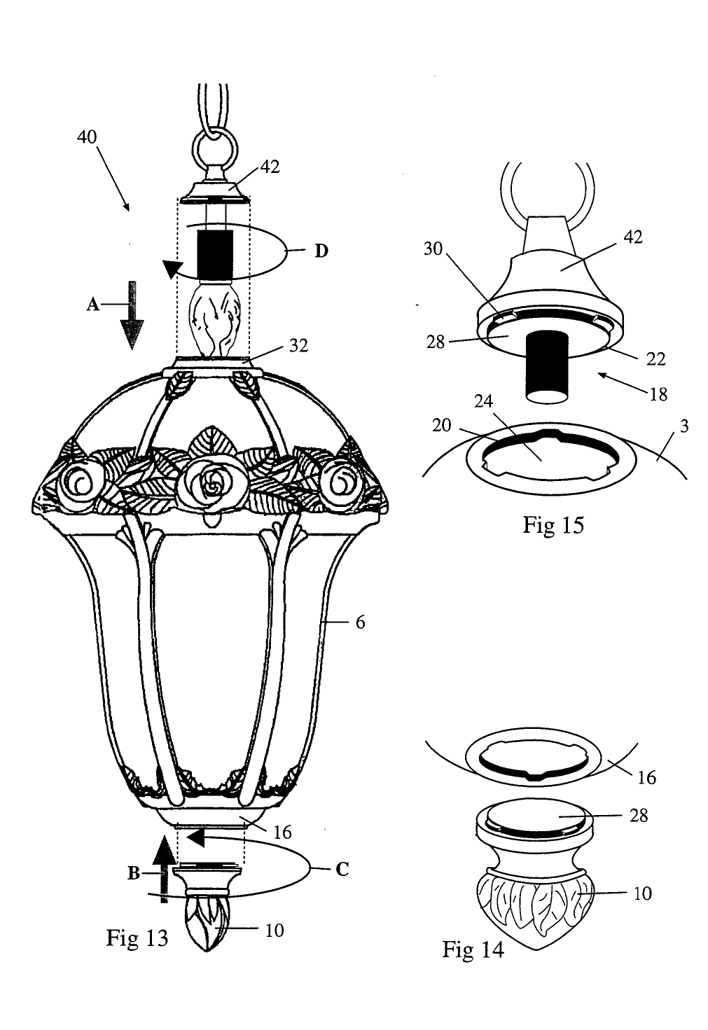

FIGS. 14 and 15 show the same locking mechanism 18 as shown in FIGS. 3, 4, 7, 8, 10 and 11. The structure of the locking mechanism is the same structure as used in FIGS. 3, 4, 7, 8, 10, and 11 however the chain mount 42 is used on the top 32 of the light fixture body 6 and the finishing piece 10 is on the bottom 16 of the light fixture assembly. This can be done because both the finishing piece 10 and the chain mount 42 have the same locking mechanism 18.

All parts for the light fixture assembly are made using a standard die casting process. A powder coating is used on the light fixture assembly for its finish. The parts and then packaged to be sold.

Various changes could be made in the above construction and method without departing from the scope of the invention as defined in the claims below. It is intended that all matter contained in the above description as shown in the accompanying drawings shall be interpreted as illustrative and not as a limitation.

1. A light fixture assembly comprising:
(a) a light fixture body;
(b) a mount for the light fixture body for attachment to a support structure; and
(c) a locking mechanism for nonthreadably releaseably coupling the light fixture body to the mount, a first portion of the locking mechanism attached to the light fixture body, a second portion of the locking mechanism attached to the mount whereby the light fixture body is attached to the mount.

2. A light fixture assembly as recited in claim 1 wherein coupling the light fixture body to the mount includes twist locking.

3. A method for assembling a light fixture comprising:
(a) providing a light fixture assembly having a light fixture body, a post mount, a chain mount, a coach mount, and a finishing piece;
(b) selecting an appropriate mounting piece; and
(c) attaching the appropriate mounting piece and the finishing piece to the light fixture body without using tools.
